(19) United States
(12) Patent Application Publication
(10) Pub. No.: US 2014/0050912 A1
(43) Pub. Date: Feb. 20, 2014

(54) GLASS SUBSTRATE FOR MAGNETIC DISK AND METHOD FOR MANUFACTURING GLASS SUBSTRATE FOR MAGNETIC DISK

(71) Applicants: Hideki Isono, Yamanashi (JP); Hidekazu Tanino, Tokyo (JP); Akira Murakami, Tokyo (JP); Takashi Sato, Tokyo (JP); Masamune Sato, Tokyo (JP)

(72) Inventors: Hideki Isono, Yamanashi (JP); Hidekazu Tanino, Tokyo (JP); Akira Murakami, Tokyo (JP); Takashi Sato, Tokyo (JP); Masamune Sato, Tokyo (JP)

(73) Assignee: HOYA CORPORATION, Shinjuku-ku, Tokyo (JP)

(21) Appl. No.: 14/001,770

(22) PCT Filed: Jun. 29, 2012
(86) PCT No.: PCT/JP2012/004258

§ 371 Date: Nov. 5, 2013

(30) Foreign Application Priority Data
Jun. 30, 2011 (JP) 2011-145197

(51) Int. Cl. G11B 5/84; G11B 5/735; C03B 11/12; C03C 21/00

(52) U.S. Cl. CPC G11B 5/8404; C03C 21/00; G11B 5/735; C03B 11/12
USPC 428/220; 65/30.14; 428/410

(57) ABSTRACT

A method for manufacturing a glass substrate for magnetic disk is provided. The method includes a forming process of press-forming a lump of molten glass using a pair of dies, wherein in the forming process, the cooling rate of the molten glass during pressing is controlled so that a first compressive stress layer is formed on a pair of principal faces of a glass blank that is press formed, and the method includes a chemically strengthening process for forming a second compressive stress layer on a pair of principal faces of a glass substrate formed using the glass blank after the forming process.

### TECHNICAL FIELD

The present invention relates to a glass substrate for magnetic disk and a method for manufacturing the same.

### BACKGROUND ART

Recently, a hard disk drive device (HDD) is incorporated in a personal computer or a DVD (Digital Versatile Disc) recording apparatus in order to record data. Particularly, in the hard disk device used in an apparatus such as the notebook personal computer based on portability, a magnetic disk in which a magnetic layer is provided on a glass substrate is used, and magnetic recording information is recorded in or read from a magnetic layer using a magnetic head (DFH (Dynamic Flying Height) head) that is slightly floated on a surface of the magnetic disk surface. A glass substrate is suitably used as the substrate for magnetic disk because the glass substrate hardly plastically deformed as compared to a metallic substrate (aluminum substrate) and the like.

The magnetic head includes, for example, a magnetic resistance effect element, but such a magnetic head may cause a thermal asperity trouble as its specific trouble. The thermal asperity trouble is a trouble in which when a magnetic head passes over a micro-irregularly-shaped surface of a magnetic disk while floating and flying, a magnetic resistance effect element is heated by adiabatic compression or contact of air, causing a read error. Thus, for avoiding the thermal asperity trouble, the glass substrate for magnetic disk is prepared such that surface properties, such as the surface roughness and flatness, of the principal face of the glass substrate are at a satisfactory level.

As a conventional method for manufacturing a sheet glass (glass blank), a vertical direct press method is known. This press method is a method in which a lump of molten glass is fed onto a lower die, and the lump of molten glass (molten glass lump) is press-formed using an upper die (Patent Document 1)

A glass substrate has a property of being a fragile material. Thus, as a method for strengthening the principal face of the glass substrate, a chemically strengthening method has been known in which a glass substrate is dipped in a heated chemically strengthening liquid to ion-exchange lithium ions and sodium ions on the principal face of the glass substrate with sodium ions and potassium ions, respectively, in the chemically strengthening liquid, thereby forming a compressive stress layer on the principal face of the glass substrate (Patent Document 2).

### PRIOR ART DOCUMENTS

### Patent Documents

Patent Document 1: Japanese Patent Laid-open Publication No. 1999-255521
Patent Document 2: Japanese Patent Laid-open Publication No. 2002-121051

### SUMMARY OF THE INVENTION

### Problems to be Solved by the Invention

In conventional glass substrates for magnetic disk, the strength of the principal face is enhanced by using a chemically strengthening method, but it is considered that a further high strength will be demanded in the future.

An object of the present invention is to provide a glass substrate for magnetic disk having a principal face, the strength of which is further enhanced as compared to a case in which only a chemically strengthening method is used, and a method for manufacturing the same.

### Means for Solving the Problems

In view of the above-described problems, the present inventors have intensively conducted studies, and resultantly found a press forming method for forming a compressive stress layer on the principal face of a glass substrate. Specifically, in this press forming method, a press stress layer can be formed on each of a pair of principal faces of a glass blank that is press formed, by controlling the cooling rate of a molten glass being pressed when a lump of molten glass is press-formed using a pair of dies. Further, the present inventors have found that by performing both the press forming method and a chemically strengthening method, a compressive stress layer having a large thickness and a high compressive stress can be formed on each of the principal faces of a glass substrate, and resultantly a glass substrate having principal faces, the strength of which is further enhanced, can be obtained.

Here, in the chemically strengthening method, the thickness of the compressive stress layer formed may be smaller than the compressive stress layer formed by the press forming method. For example, the thickness of the compressive stress layer formed by the press forming method may be about 100 to 300 μm, although it may vary depending on the thickness and thermal expansion coefficient of the glass substrate, while the thickness of the compressive stress layer formed by the chemically strengthening method may be about 10 to 100 μm.

The compressive stress generated in the compressive stress layer formed by the chemically strengthening method can be almost equal to the compressive stress generated in the compressive stress layer formed by the press forming method. For example, the magnitude of the compressive stress generated in the compressive stress layer formed by the chemically strengthening method is about 10 to 50 Kg/mm², while the magnitude of the compressive stress generated in the compressive stress layer formed by the press forming method is about 0.1 to 50 Kg/mm².

Therefore, by combining the chemically strengthening method and the press forming method, a glass substrate having on the principal face a compressive stress layer having a large thickness and a high compressive stress can be formed as compared to a case in which only the chemically strengthening method is used.

From the viewpoint described above, the first aspect of the present invention may be a method for manufacturing a glass substrate for magnetic disk, which includes a forming process of press-forming a lump of molten glass using a pair of dies, during which the cooling rate of the molten glass during pressing is controlled so that a first compressive stress layer is formed on each of a pair of principal faces of a glass blank that is press formed; and a chemically strengthening process for forming a second compressive stress layer on each of a pair of principal faces of a glass substrate formed using the glass blank after the forming process.

In the method for manufacturing a glass substrate for magnetic disk, preferably, in the forming process, the falling lump of molten glass may be press-formed using the pair of dies from directions, each direction being orthogonal to the falling direction.

In the method for manufacturing a glass substrate for magnetic disk, in the forming process, press forming may be performed so that the temperature of the press forming surface of the pair of dies is substantially identical.

In the method for manufacturing a glass substrate for magnetic disk, the temperature of the pair of dies may be kept lower than the glass transition point (Tg) of the molten glass during a period of time from when the glass blank contacts the pair of dies to the time the glass blank separates from the pair of dies.

In the method for manufacturing a glass substrate for magnetic disk, wherein the method may include a polishing process for partially removing the first compressive stress layer and the second compressive stress layer formed on a pair of principal faces of the glass substrate after the chemically strengthening process.

The second aspect of the present invention may be a glass substrate for magnetic disk having a pair of principal faces, the glass substrate including a compressive stress layer formed with chemically strengthening, and a compressive stress layer formed with physically strengthening, the compressive stress layers being overlapping each other.

Thickness of the glass substrate for magnetic disk described above may be 0.5 to 1.0 mm.

### Effects of the Invention

According to the present invention, a glass substrate for magnetic disk having a principal face, the strength of which is further enhanced, can be manufactured as compared to a case in which only a chemically strengthening method is used.

### BRIEF DESCRIPTION OF THE DRAWINGS

FIG. 1 is a perspective view illustrating an external shape of a glass substrate for magnetic disk of an embodiment.

FIG. 2 is a view illustrating a flow of one embodiment of a method for manufacturing the glass substrate for magnetic disk of the embodiment.

FIG. 3 is a plan view of an apparatus used in press forming of the embodiment.

FIG. 4 is a view explaining press forming of the embodiment.

FIG. 5 is a view illustrating a modification of press forming of the embodiment using a gob forming die.

FIG. 6 is a view illustrating a modification of press forming of the embodiment in which a cutting unit is not used.

FIG. 7 is a view illustrating a modification of press forming of the embodiment using an optical glass heated by a softening furnace.

FIG. 8 is a view illustrating a modification of cooling control means used in press forming of the embodiment.

FIG. 9 is a view illustrating a state of a compressive stress layer of the embodiment.

### DESCRIPTION OF THE PREFERRED EMBODIMENTS

A glass substrate for magnetic disk in this embodiment and a method for manufacturing the same will be described in detail below.

[Glass Substrate for Magnetic Disk]

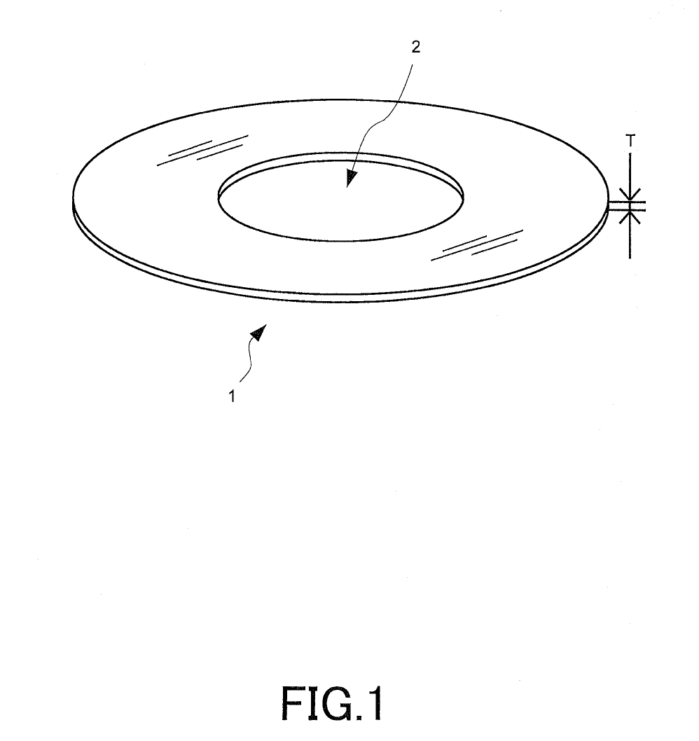

As illustrated in FIG. 1, a glass substrate for magnetic disk 1 in this embodiment is a donut-shaped thin glass substrate. The size of the glass substrate for magnetic disk is not limited but for example, a glass substrate for magnetic disk having a nominal diameter of 2.5 inches is suitable. In the case of the glass substrate for magnetic disk having a nominal diameter of 2.5 inches, for example, the outer diameter is 65 mm, the diameter of a central hole 2 is 20 mm, and the thickness T is 0.5 to 1.0 mm. The flatness of the principal face of the glass substrate for magnetic disk of the embodiment is, for example, 4 μm or less, and the surface roughness (arithmetic mean roughness Ra) of the principal face is, for example, 0.2 nm or less. It is to be noted that the flatness required for a substrate for magnetic disk as a final product is, for example, 4 μm or less.

Amorphous aluminosilicate glass, soda-lime glass, borosilicate glass or the like can be used as a material of the glass substrate for magnetic disk in this embodiment. Particularly, the amorphous aluminosilicate glass can be suitably used in that chemically strengthening can be performed, and a glass substrate for magnetic disk excellent in flatness of the principal face and strength of the substrate can be prepared. It is preferable if amorphous glass is prepared based on these glass materials because extremely small surface roughness is achieved. In view of the above, it is preferable from the both aspect of strength and reduction in surface roughness if amorphous aluminosilicate glass is prepared.

The composition of the glass substrate for magnetic disk of this embodiment is not limited, but the glass substrate of this embodiment may be preferably made of amorphous aluminosilicate glass having a composition including 50 to 75% of SiO₂, 1 to 15% of Al₂O₃, 5 to 35% in total of at least one component selected from Li₂O, Na₂O and K₂O, 0 to 20% in total of at least one component selected from MgO, CaO, SrO, BaO and ZnO and 0 to 10% in total of at least one component selected from ZrO₂, TiO₂, La₂O₃, Y₂O₃, Ta₂O₅, Nb₂O₅ and HfO₂ in an oxide-based conversion indicated in mol %.

The glass substrate according to the present embodiment may be amorphous aluminosilicate glass having the following composition.

Glass material including, as a glass composition expressed in mol %,

56 to 75% of SiO₂,

1 to 11% of Al₂O₃,

more than 0% and 4% or less of Li₂O,

1% or more and less than 15% of Na₂O, and

0% or more and less than 3% of K₂O, and is substantially free of BaO;

a total content of alkali metal oxides selected from the group consisting of Li₂O, Na₂O, and K₂O is in a range of 6 to 15%;

a molar ratio of a content of Li₂O to a content of Na₂O(Li₂O/Na₂O) is less than 0.50;

a molar ratio of a content of K₂O to the total content of the alkali metal oxides {K₂O/(Li₂O+Na₂O+K₂O)} is 0.13 or less;

a total content of alkaline-earth metal oxides selected from the group consisting of MgO, CaO, and SrO is in a range of 10 to 30%;

a total content of MgO and CaO is in a range of 10 to 30%;

a molar ratio of the total content of MgO and CaO to the total content of the alkaline-earth metal oxides {(MgO+CaO)/(MgO+CaO+SrO)} is 0.86 or more;

a total content of the alkali metal oxides and the alkaline-earth metal oxides is in a range of 20 to 40%;

a molar ratio of a total content of MgO, CaO, and Li₂O to the total content of the alkali metal oxides and the alkaline-earth metal oxides {(MgO+CaO+Li₂O)/(Li₂O+Na₂O+K₂O+MgO+CaO+SrO)} is 0.50 or more;

a total content of oxides selected from the group consisting of ZrO₂, TiO₂, Y₂O₃, La₂O₃, Gd₂O₃, Nb₂O₅, and Ta₂O₅ is more than 0% and 10% or less; and

a molar ratio of the total content of the oxides to a content of Al₂O₃ {(ZrO₂+TiO₂+Y₂O₃+La₂O₃+Gd₂O₃+Nb₂O₅+Ta₂O₅)/Al₂O₃} is 0.40 or more.

The glass substrate according to the present embodiment may be amorphous aluminosilicate glass having the following composition.

Glass material including, as a glass composition expressed in mol %, 50 to 75% of SiO₂, 0 to 5% of Al₂O₃, 0 to 3% of Li₂O, 0 to 5% of ZnO, 3 to 15% in total of Na₂O and K₂O, 14 to 35% in total of MgO, CaO, SrO, and BaO and 2 to 9% in total of ZrO₂, TiO₂, La₂O₃, Y₂O₃, Yb₂O₃, Ta₂O₅, Nb₂O₅ and HfO₂,

a molar ratio [(MgO+CaO)/(MgO+CaO+SrO+BaO)] is in a range of 0.8 to 1, and

a molar ratio [Al₂O₃/(MgO+CaO)] is in a range of 0 to 0.30.

[Method for Manufacturing Glass Substrate for Magnetic Disk of Embodiment]

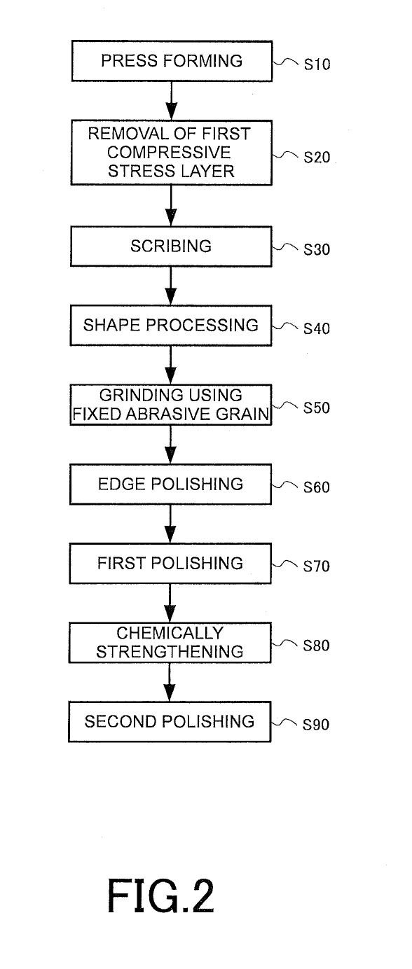

Next, a flow of a method for manufacturing a glass substrate for magnetic disk will be described with reference to FIG. 2. FIG. 2 is a view illustrating a flow of one embodiment of a method for manufacturing a glass substrate for magnetic disk.

As illustrated in FIG. 2, in the method for manufacturing a glass substrate for magnetic disk in this embodiment, first a disk-shaped glass blank is prepared by press forming (Step S10). Next, the compressive stress layer formed on the principal face of the prepared glass blank is removed in such a manner as to leave a part of the compressive stress layer (Step S20). Next, the glass blank is scribed to prepare a donut-shaped glass substrate (Step S30). Next, the scribed glass substrate is subjected to shape processing (chamfering processing) (Step S40). Next, the glass substrate is subjected to grinding using a fixed abrasive grain (Step S50). Next, edge polishing of the glass substrate is performed (Step S60). Next, the principal face of the glass substrate is subjected to first polishing (Step S70). Next, the glass substrate, after first polishing, is subjected to chemically strengthening (Step S80). Next, the chemically strengthened glass substrate is subjected to second polishing (Step S90). The glass substrate for magnetic disk is obtained through the above processes.

Each process will be described in detail below.

(a) Press Forming Process (Step S10)

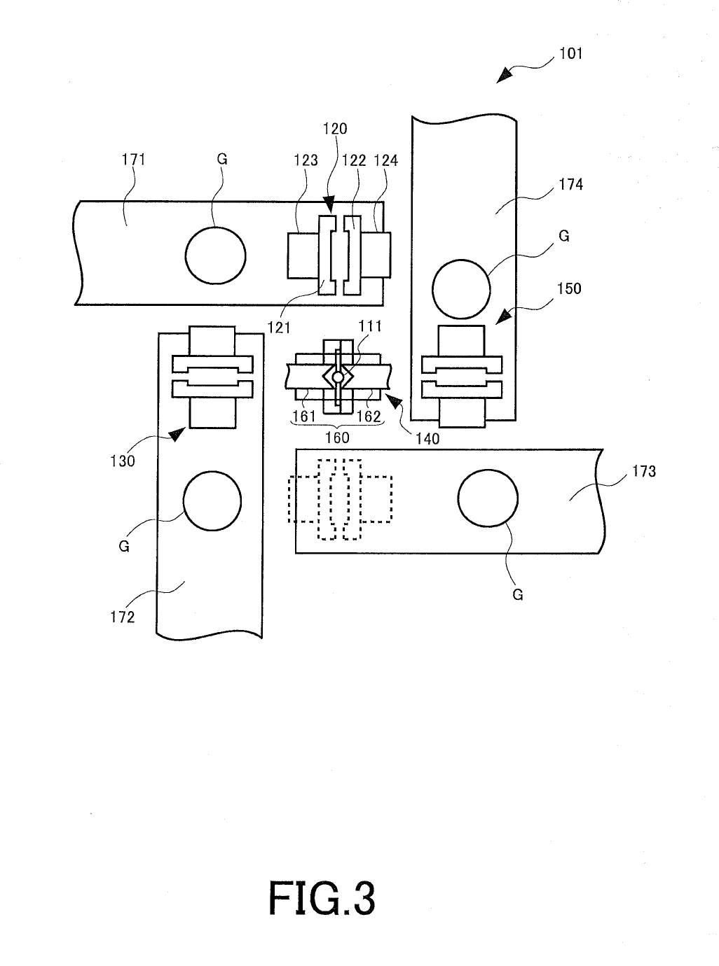

First, the press forming process will be described with reference to FIG. 3. FIG. 3 is a plan view of an apparatus used in press forming. As illustrated in FIG. 3, an apparatus 101 includes four sets of press units 120, 130, 140 and 150, a cutting unit 160 and a cutting blade 165 (not illustrated in FIG. 2). The cutting unit 160 is provided on a path of a molten glass that flows out from a molten glass outflow port 111. In the apparatus 101, a lump of molten glass (hereinafter, also referred to as a gob) cut by the cutting unit 160 is caused to fall down, and the lump is pressed from both sides of the falling path of the lump while the lump is sandwiched between surfaces of a pair of dies facing each other, thereby forming the glass blank.

Specifically, as illustrated in FIG. 3, in the apparatus 101, the four sets of press units 120, 130, 140, and 150 are provided at intervals of 90 degrees around the molten glass outflow port 111.

Each of the press units 120, 130, 140, and 150 is driven by a moving mechanism (not illustrated) so as to be able to proceed and retreat with respect to the molten glass outflow port 111. That is, each of the press units 120, 130, 140, and 150 can be moved between a catch position and a retreat position. The catch position (position in which the press unit 140 is drawn by a solid line in FIG. 3) is located immediately below the molten glass outflow port 111. The retreat position (positions in which the press units 120, 130, and 150 are drawn by solid lines and a position in which the press units 140 is drawn by a broken line in FIG. 3) is located away from the molten glass outflow port 111.

The cutting unit 160 is provided on a path of the molten glass between the catch position (position in which the gob is captured by the press unit) and the molten glass outflow port 111. The cutting unit 160 forms the lump of molten glass by cutting a proper quantity of the molten glass flowing out from the molten glass outflow port 111. The cutting unit 160 includes a pair of cutting blades 161 and 162. The cutting blades 161 and 162 are driven so as to intersect each other on the path of the molten glass at constant timing. When the cutting blades 161 and 162 intersect each other, the molten glass is cut to obtain the gob. The obtained gob falls down toward the catch position.

The press unit 120 includes a first die 121, a second die 122, a first driving unit 123, a second driving unit 124 and a cooling control unit 125. Each of the first die 121 and the second die 122 is a plate-shaped member including a surface (press forming surface) used to perform the press forming for the gob. The press forming surface may be circular, for example. The first die 121 and the second die 122 are disposed such that normal directions of the surfaces become substantially horizontal, and such that the surfaces become parallel to each other. It should be noted that each of the die 121 and the die 122 is not limited to be plate-shaped so long as each die includes a press forming surface. The first driving unit 123 causes the first die 121 to proceed and retreat with respect to the second die 122. On the other hand, the second driving unit 124 causes the second die 122 to proceed and retreat with respect to the first die 121. Each of the first driving unit 123 and the second driving unit 124 includes a mechanism for causing the surface of the first driving unit 123 and the surface of the second driving unit 124 to be rapidly brought close to each other, for example, a mechanism in which an air cylinder or a solenoid and a coil spring are combined.

The cooling control unit 125 causes heat to be conducted easily in respective press forming surface of the first and second die 121, 122 during press-forming the gob, and accordingly control the cooling rate of the gob during press-forming. The cooling control unit 125 is a heat sink for example, and is one example of cooling control means for controlling the cooling rate of a gob during press-forming. The cooling control unit 125 controls the cooling rate of the gob so that a compressive stress layer (first compressive stress layer) is formed on a pair of principal faces of a glass blank formed after the process of press-forming the gob. The cooling control unit 125 is provided so as to contact entire surfaces opposite to the press forming surfaces of first and second dies 121 and 122. Preferably the cooling control unit 125 is formed of a material having heat conductivity higher than that of each of first and second dies 121 and 122. For example, when first and second dies 121 and 122 are formed of an ultrahard alloy (e.g. VM40), the cooling control unit 125 may be formed of copper, a copper alloy, aluminum, an aluminum alloy or the like. Since the cooling control unit 125 has heat conductivity higher than that of each of first and second dies 121 and 122, heat transferred to first and second dies 121 and 122 from the gob can be efficiently discharged to outside. The heat conductivity of the ultrahard alloy (VM40) is 71 (W/m·K), and the heat conductivity of copper is 400 (W/m·K). The member that forms the cooling control unit 125 may be appropriately selected according to the heat conductivity, hardness, thickness and dimension, etc. of the metal forming first and second dies 121 and 122. First and second dies 121 and 122 are required to have strength capable of sustaining press, and therefore preferably they are not integrated with the cooling control unit 125.

A heat wasting mechanism including a passage of liquid or air, etc. having cooling effect, and/or, a heating mechanism such as heater, etc. may be prepared as a cooling controlling means for controlling the cooling rate of the gob during press-forming.

Because the structures of the press units 130, 140, and 150 are similar to that of the press unit 120, the descriptions of the press units 130, 140, and 150 are omitted. Control of the cooling rate of the gob G_{G} will be described later.

After each press unit moves to the catch position, the falling gob is sandwiched between the first die and the second die by driving the first driving unit and the second driving unit, and the gob is formed into a predetermined thickness while cooled, thereby preparing a circular glass blank G. Load applied (pressing pressure) may be preferably in the range of 2,000 to 15,000 kgf. Being accelerated sufficiently within the range, press units enables short time pressing. Then, the gob may be formed into thickness suitable for a glass blank for a magnetic disk irrespective of glass material. Next, after the press unit moves to the retreat position, the first die and the second die are separated to cause the formed glass blank G to fall down. A first conveyer 171, a second conveyer 172, a third conveyer 173, and a fourth conveyer 174 are provided below the retreat positions of the press units 120, 130, 140, and 150, respectively. Each of the first to fourth conveyers 171 to 174 receive the glass blank G falling down from the corresponding press unit, and the conveyer conveys the glass blank G to an apparatus (not illustrated) of the next process.

The apparatus 101 is configured such that the press units 120, 130, 140, and 150 sequentially move to the catch position and move to the retreat position while the gob is sandwiched, so that the glass blank G can continuously be formed without waiting for the cooling of the glass blank G in each press unit.

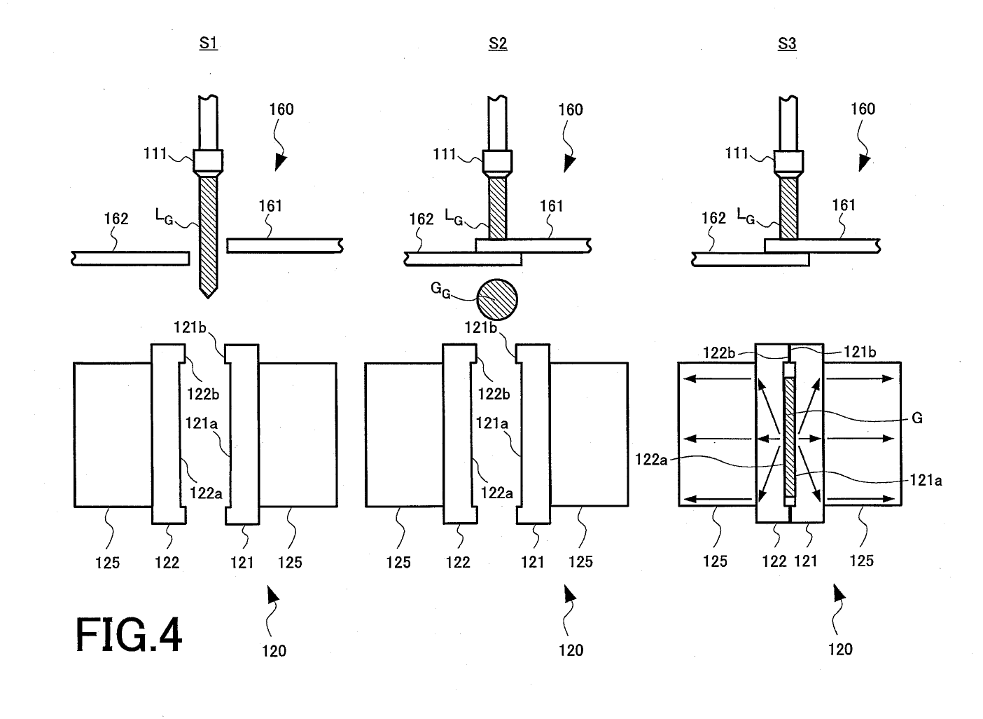

FIG. 4 (a) to FIG. 4 (c) more specifically illustrates press forming performed by the apparatus 101. FIG. 4 (a) is a view illustrating the state before the gob is made, FIG. 4 (b) is a view illustrating the state in which the gob is made by the cutting unit 160, and FIG. 4 (c) is a view illustrating the state in which the glass blank G is formed by pressing the gob.

As illustrated in FIG. 4 (a), a molten glass material L_{G} continuously flows out from the molten glass outflow port 111. At this point, the cutting unit 160 is driven at predetermined timing to cut the molten glass material L_{G} using the cutting blades 161 and 162 (FIG. 4 (b)). Therefore, the cut molten glass becomes a substantially spherical gob G_{G} due to a surface tension thereof. Adjustment of the outflow quantity per time of the molten glass material L_{G} and the driving interval of the cutting unit 160 may be appropriately performed according to a volume determined by the target size and thickness of the glass blank G.

The made gob G_{G} falls down toward a gap between the first die 121 and second die 122 of the press unit 120. At this point, the first driving unit 123 and the second driving unit 124 (see FIG. 4) are driven such that the first die 121 and the second die 122 come close to each other at the timing the gob G_{G} enters the gap between the first die 121 and the second die 122. Therefore, as illustrated in FIG. 4 (c), the gob G_{G} is captured (caught) between the first die 121 and the second die 122. An inner circumferential surface 121a (press forming surface) of the first die 121 and an inner circumferential surface 122a (press forming surface) of the second die 122 come close to each other with a micro gap, and the gob G_{G} sandwiched between the inner circumferential surface 121a of the first die 121 and the inner circumferential surface 122a of the second die 122 is formed into a thin-plate shape. A projection 121b and a projection 122b are provided in the first inner circumferential surface 121a of the first die 121 and the second inner circumferential surface 122a of the second die 122, respectively, in order to keep the gap between the inner circumferential surface 121a of the first die 121 and the inner circumferential surface 122a of the second die 122 constant. That is, the projection 121b and the projection 122b abut against each other, whereby the gap between the inner circumferential surface 121a of the first die 121 and the inner circumferential surface 122a of the second die 122 is kept constant, so that a plate-shaped space is generated.

Press forming is performed using a pair of dies 121 and 122 in the press forming process in press forming in this embodiment, and the outer shape of the glass blank is not restricted by the shape of the die. That is, as illustrated in FIG. 4 (c), the gob stretched by closed dies does not reach projections 121b and 122b.

As illustrated in FIG. 4 (c), heat transferred to central portions of inner circumferential surfaces 121a and 122a from the gob G_{G} is discharged to outside through the cooling control unit 125 in accordance with a flow of heat illustrated by the arrow in the figure.

A temperature control mechanism (not illustrated) is provided in each of the first die 121 and second die 122, and temperatures at the first die 121 and second die 122 is retained sufficiently lower than the glass transition point T_{G} of the molten glass L_{G}. That is, the temperature control mechanism can increase or reduce the cooling rate of the gob G_{G} sandwiched between the inner circumferential surface 121a of the first die 121 and the inner circumferential surface 122a of the second die 122. Therefore, the temperature control mechanism may have a cooling mechanism including, for example, a path of a liquid, a gas or the like having a cooling effect, or a heating mechanism such as a heater.

It is not necessary to attach a mold release material to the first die 121 and the second die 122 in the press forming process.

The flatness of the glass blank obtained after press forming becomes better as a difference in temperature between the central portion and the circumferential edge portion of the inner circumferential surface 121a of the first die 121, and a difference in temperature between the central portion and the circumferential edge portion of the inner circumferential surface 122a of the second die 122 (that is, a difference in temperature of the press forming surface) decrease at the time of press-forming the gob G_{G}. Particularly, it is preferable to decrease the difference in temperature by efficiently discharging heat from the gob G_{G}, which is easily confined in the central portion of each of inner circumferential surfaces 121a and 122a, to outside. This is because when a difference in temperature of the press forming surface during press forming is decreased, the temperature of the central portion and the temperature of the circumferential edge portion of the inner circumferential surface are almost identical, so that the central portion and the circumferential edge portion of the gob G_{G} can be solidified almost at the same time.

Since the temperature of the central portion and the temperature of the circumferential edge portion of the inner circumferential surface are almost identical, an internal strain (in-plane strain) by a compressive stress directing from the circumferential edge portion to the central portion of the press forming surface can be prevented from being generated in the press-formed glass blank. Resultantly, surface waviness of the glass blank obtained after the press forming becomes excellent.

Thus, by reducing a difference in temperature of the press forming surface during pressing of the glass blank using the cooling control unit 125, flatness required for the glass substrate for magnetic disk can be achieved, and the central portion and the circumferential edge portion of the gob G_{G} can be solidified at the same time. For example, if the flatness required for the glass substrate for magnetic disk is 4 μm, press forming is performed while the difference in temperature between the central portion and the circumferential edge portion of the inner circumferential surface is kept at 10° C. or less. Generation of the in-plane strain of the glass blank is best prevented when a difference in temperature between the central portion and the circumferential edge portion is 0° C. The difference in temperature may be appropriately determined according to the size of the glass blank G formed, the composition of the glass, and so on.

Here, the difference in temperature of the press forming surface is a difference in temperature which is the largest of differences in temperature between the central portion and each circumferential edge portion as measured using a thermocouple at a point which is located 1 mm from the front face of inner circumferential surface of the die to the inside of the die and corresponds to each of the central portion and a plurality of circumferential edge portions of the inner circumferential surface (e.g. a point corresponding to the central position of a glass blank having a diameter of 75 mm and upper and lower and left and right four positions on the circumference of a circle centered on the aforementioned point and having a radius of about 30 mm).

Next, a difference in temperature between the first die 121 and the second die 122 may be determined from the following viewpoint according to flatness required for the glass substrate for magnetic disk.

Since glass substrate for magnetic disk of this embodiment is incorporated while being pivotally supported by a metallic spindle having a high thermal expansion coefficient within a hard disk as a magnetic disk that is a final product, the thermal expansion coefficient of the glass substrate for magnetic disk is preferably as high as that of the spindle. Therefore, the composition of the glass substrate for magnetic disk is defined so that the glass substrate for magnetic disk has a high thermal coefficient. The thermal expansion coefficient of the glass substrate for magnetic disk is, for example, in a range of 30×10⁻⁷ to 100×10⁻⁷(K⁻¹), preferably in a range of 50×10⁻⁷ to 100×10⁻⁷(K⁻¹), ever more preferably equal to or more than 80×10⁻⁷(K⁻¹). The thermal expansion coefficient is a value calculated using the linear expansion coefficients of the glass substrate for magnetic disk at temperatures of 100° C. and 300° C. A thermal expansion coefficient of, for example, less than 30×10⁻⁷(K⁻¹) or more than 100×10⁻⁷ is not preferable because a difference in thermal expansion coefficient between the glass substrate and the spindle is increased. From the point of view, temperature conditions at the circumference of the principal face of the glass blank are made uniform in the press forming process when a glass substrate for magnetic disk having a high thermal expansion coefficient is prepared. As one example, it is preferable to perform temperature control so that the temperatures of the inner circumferential surface 121a of the first die 121 and the inner circumferential surface 122a of the second die 122 become substantially identical. When temperature control is performed so that the temperatures become identical, for example, a difference in temperature is preferably 5° C. or less. The difference in temperature is more preferably 3° C. or less, especially preferably 1° C. or less.

The difference in temperature between dies is a difference in temperature as measured using a thermocouple at a point which is located 1 mm from each of the front faces of the inner circumferential surface 121a of the first die 121 and the inner circumferential surface 122a of the second die 122 to the inside of the die and at which the inner circumferential surface 121a and the inner circumferential surface 122a face each other (e.g. a point corresponding to the central position of the glass blank and central points of the inner circumferential surface 121a and the inner circumferential surface 122a). The difference in temperature between the dies is measured when the gob contacts the first die 121 and the second die 122.

A time until the gob G_{G} is completely confined between the first die 121 and the second die 122 after the gob G_{G} comes into contact with the inner circumferential surface 121a of the first die 121 or the inner circumferential surface 122a of the second die 122, is shorter than 0.1 second (approximately 0.06 second) in the apparatus 101. Therefore, the gob G_{G} is formed into the substantially disk shape by spreading along the inner circumferential surface 121a of the first die 121 and the inner circumferential surface 122a of the second die 122 within an extremely short time, and the gob G_{G} is cooled and solidified in the form of amorphous glass. In this way, the glass blank G is prepared. The size of the glass blank G formed in this embodiment is, depending on the size of a desired glass substrate for magnetic disk, for example about 20 to 200 mm in diameter.

In the press forming method of this embodiment, the glass blank G is formed in a manner such that the shapes of the inner circumferential surface 121a of the first die 121 and the inner circumferential surface 122a of the second die 122 are duplicated, and therefore preferably the flatness and the smoothness of each of the inner circumferential surfaces of a pair of dies are made comparable to those of a desired glass substrate for magnetic disk. In this case, necessity to subject the glass blank G to a surface processing process, i.e. a grinding and polishing process after press forming may be eliminated. That is, the thickness of the glass blank G formed in the press forming method of this embodiment may be the sum of the target thickness of the glass substrate for magnetic disk that is finally obtained and the thickness of the compressive stress layer that is removed in the removing process described later. For example, the glass blank G is preferably a disk-shaped sheet having a thickness of 0.2 to 1.1 mm. The surface roughness of each of the inner circumferential surface 121a and the inner circumferential surface 122a are substantially uniform in the whole surfaces, and are adjusted so that the arithmetic mean roughness Ra of the glass blank G is preferably 0.0005 to 0.05 μm, more preferably 0.001 to 0.1 μm. The surface roughness of the glass blank G is duplicated from surface properties of the inner circumferential surface 121a and the inner circumferential surface 122a, and is therefore uniform in the whole surfaces.

After the first die 121 and the second die 122 are closed, the press unit 120 quickly moves to the retreat position, instead the press unit 130 moves to the catch position, and the press unit 130 performs the pressing to the gob G_{G}.

After the press unit 120 moves to the retreat position, the first die 121 and the second die 122 are kept closed until the glass blank G is sufficiently cooled (at least until the glass blank G has a temperature below a yield point). Then, the first driving unit 123 and the second driving unit 124 are driven to separate the first die 121 and the second die 122, the glass blank G falls down from the press unit 120, and the conveyer 171 located below the press unit 120 receives the glass blank G (see FIG. 3).

As described above, in the apparatus 101, the first die 121 and the second die 122 are closed within a time as extremely short as 0.1 second (about 0.06 second), and the molten glass substantially simultaneously comes into contact with the whole of the inner circumferential surface 121a of the first die 121 and the whole of the inner circumferential surface 122a of the second die 122. Therefore, the inner circumferential surface 121a of the first die 121 and the inner circumferential surface 122a of the second die 122 are not locally heated, and a strain is hardly generated in the inner circumferential surface 121a and the inner circumferential surface 122a. Because the molten glass is formed into the disk shape before the heat transfers from the molten glass to the first die 121 and the second die 122, a temperature distribution of the formed molten glass becomes substantially even. Therefore, in cooling the molten glass, variation of the shrinkage quantity of the glass material is small, and the large strain is not generated in the principal face of the glass blank G. Accordingly, the flatness of the principal face of the prepared glass blank G is improved as compared to a glass blank prepared by conventional press forming with an upper die and a lower die.

In the example illustrated in FIG. 4, the substantially spherical gob G_{G} is formed by cutting the flowing-out molten glass L_{G} using the cutting blades 161 and 162. However, when viscosity of the molten glass material L_{G} is small with respect to a volume of the gob G_{G} to be cut, the glass does not become the substantially spherical shape only by cutting the molten glass L_{G}, and the gob is not formed. In such cases, a gob forming die is used to form the gob.

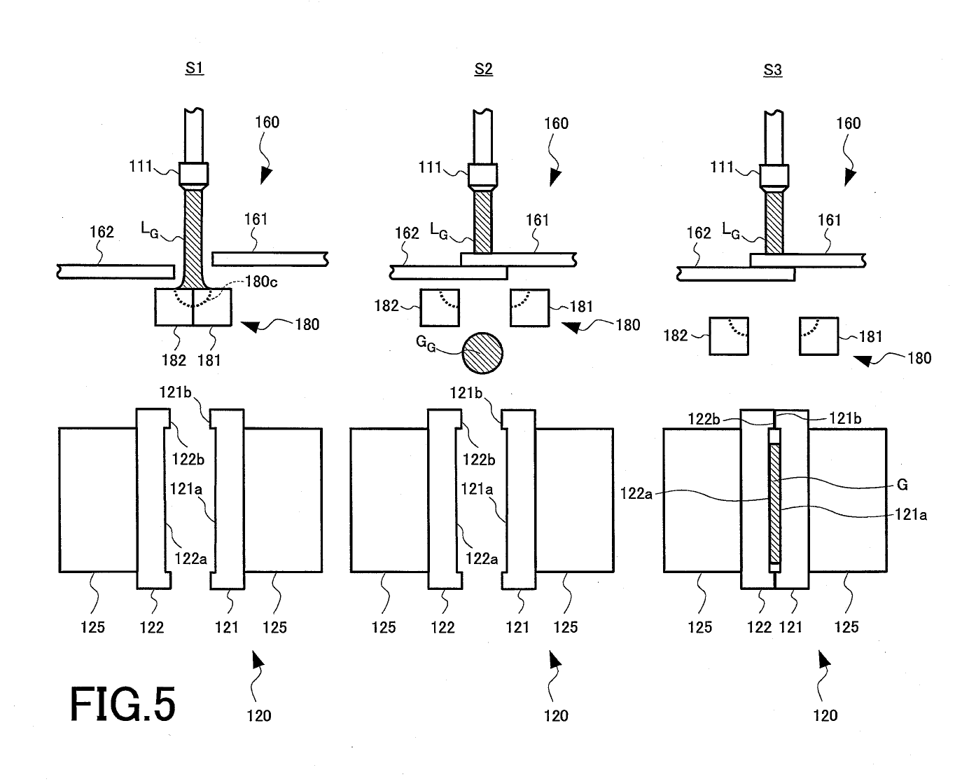

FIG. 5 (a) to FIG. 5 (c) are views illustrating a modification of the embodiment of FIG. 4. The gob forming die is used in the modification. FIG. 5 (a) is a view illustrating the state before the gob is made, FIG. 5 (b) is a view illustrating the state in which the gob G_{G} is made by the cutting unit 160 and a gob forming die 180, and FIG. 5 (c) is a view illustrating the state in which the press forming is performed to the gob G_{G} to make the glass blank G.

As illustrated in FIG. 5 (a), the path of the molten glass L_{G} to the press unit 120 is closed by closing the blocks 181 and 182, and the lump of the molten glass L_{G} cut with the cutting unit 160 is received by a recess 180C formed by the block 181 and 182. Then, as illustrated in FIG. 5 (b), the molten glass L_{G} that becomes the spherical shape in the recess 180C falls down toward the press unit 120 at one time by opening the blocks 181 and 182. When falling down toward the press unit 120, the gob G_{G} becomes the spherical shape by the surface tension of the molten glass L_{G}. As illustrated in FIG. 5 (c), during the fall of the gob G_{G}, the spherical gob G_{G} is sandwiched between the first die 121 and the second die 122 to perform the press forming, thereby preparing the disk-shaped glass blank G.

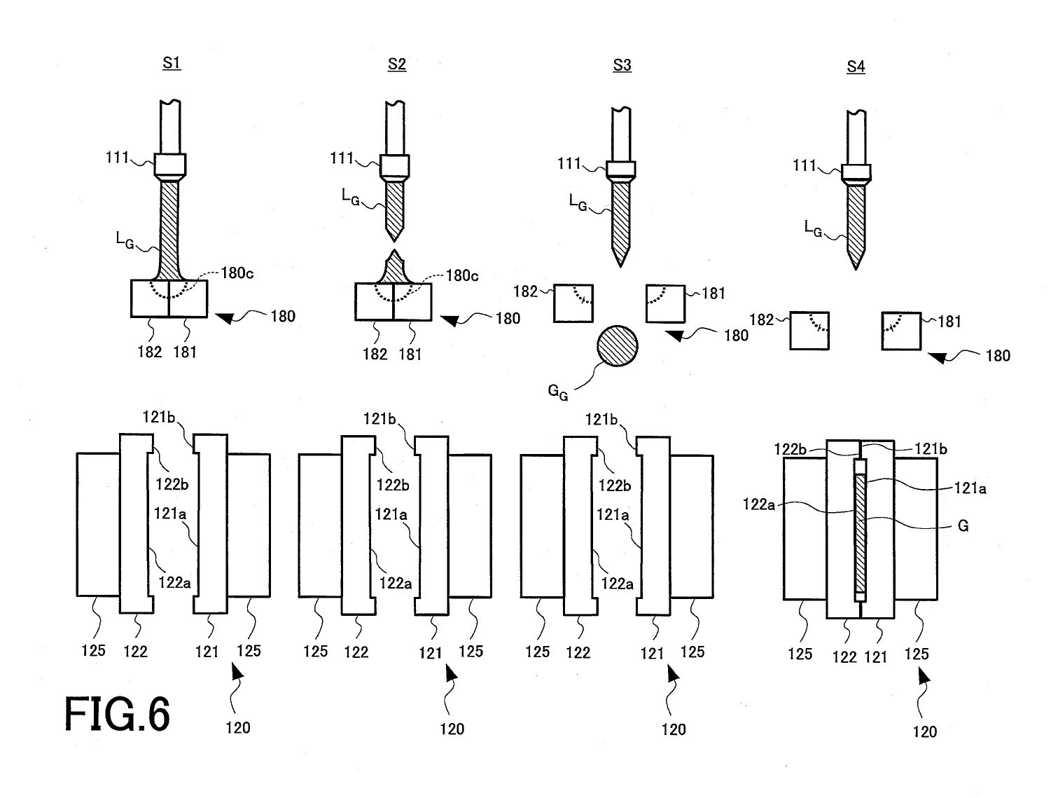

Alternatively, as illustrated in FIG. 6 (a) to FIG. 6 (d), in the apparatus 101, instead of using the cutting unit 160 illustrated in FIG. 5 (a) to FIG. 5 (c), a moving mechanism that moves the gob forming die 180 in an upstream direction or a downstream direction along the path of the molten glass L_{G} may be used. FIG. 6 (a) to FIG. 6 (d) are views illustrating a modification in which the gob forming die 180 is used. FIG. 6 (a) and FIG. 6 (b) are views illustrating the state before the gob G_{G} is made, FIG. 6 (c) is a view illustrating the state in which the gob G_{G} is made by the gob forming die 180, and FIG. 6 (d) is a view illustrating the state in which the gob G_{G} is subjected to press forming to make the glass blank G.

As illustrated in FIG. 6 (a), the recess 180C formed by the block 181 and 182 receives the molten glass L_{G} flowing out from the molten glass outflow port 111. As illustrated in FIG. 6 (b), the blocks 181 and 182 are quickly moved onto the downstream side of the flow of the molten glass L_{G} at predetermined timing. In this way, the molten glass L_{G} is cut. Then, as illustrated in FIG. 6 (c), the blocks 181 and 182 are separated at predetermined timing. Therefore, the molten glass L_{G} retained by the blocks 181 and 182 falls down at one time, and the gob G_{G} becomes the spherical shape by the surface tension of the molten glass L_{G}. As illustrated in FIG. 6 (d), during the fall of the gob G_{G}, the spherical gob G_{G} is sandwiched between the first die 121 and the second die 122 to perform the press forming, thereby preparing the disk-shaped glass blank G.

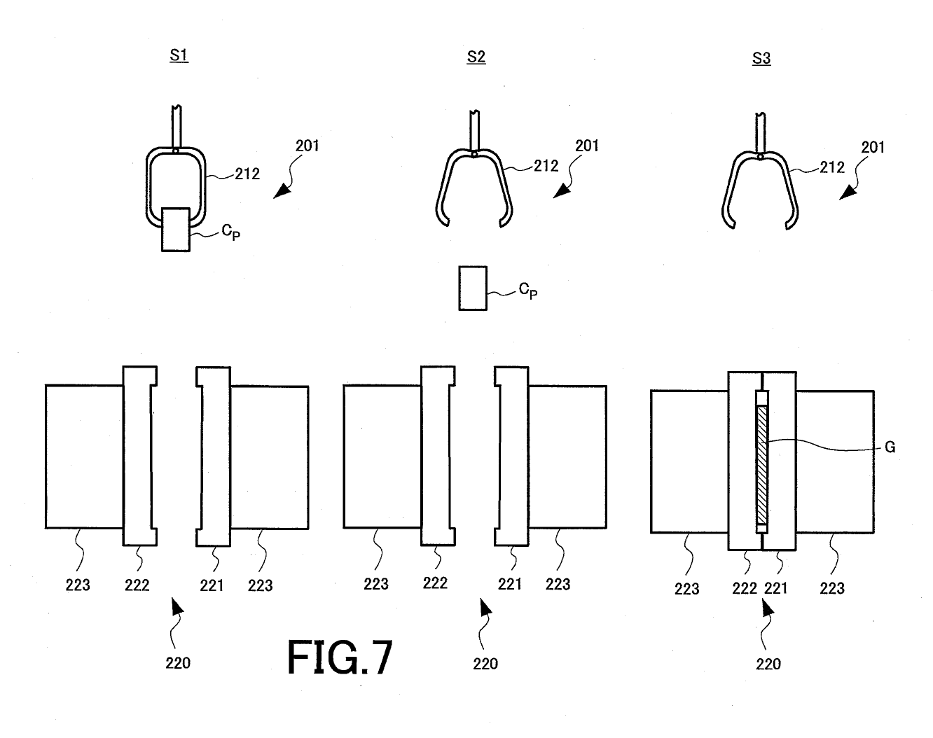

FIG. 7 (a) to FIG. 7 (c) are views illustrating another modification in which, instead of the gob G_{G}, a lump C_{P} of the optical glass heated by a softening furnace (not illustrated) is caused to fall down and the press forming is performed to the lump C_{P} while the lump C_{P} is sandwiched from both sides between dies 221 and 222 during the fall of the lump C_{P}. FIG. 7 (a) is a view illustrating the state before the lump of the heated optical glass is formed. FIG. 7 (b) is a view illustrating the state in which the lump of the optical glass falls down. FIG. 7 (c) is a view illustrating the state in which the press forming is performed to the lump of the optical glass to make the glass blank G.

As illustrated in FIG. 7 (a), in an apparatus 201, a glass material grasping mechanism 212 conveys the lump C_{P} of the optical glass to a position above a press unit 220. As illustrated in FIG. 7 (b), the glass material grasping mechanism 212 releases the lump C_{P} of the optical glass to cause the lump C_{P} of the optical glass to fall down. As illustrated in FIG. 7 (c), during the fall of the lump C_{P} of the optical glass, the lump C_{P} is sandwiched between the first die 221 and the second die 222 to perform the press forming, thereby preparing the disk-shaped glass blank G. Because the first die 221 and the second die 222 have the same configuration and action as those of the first die 121 and second die 122 illustrated in FIG. 5, the descriptions are omitted.

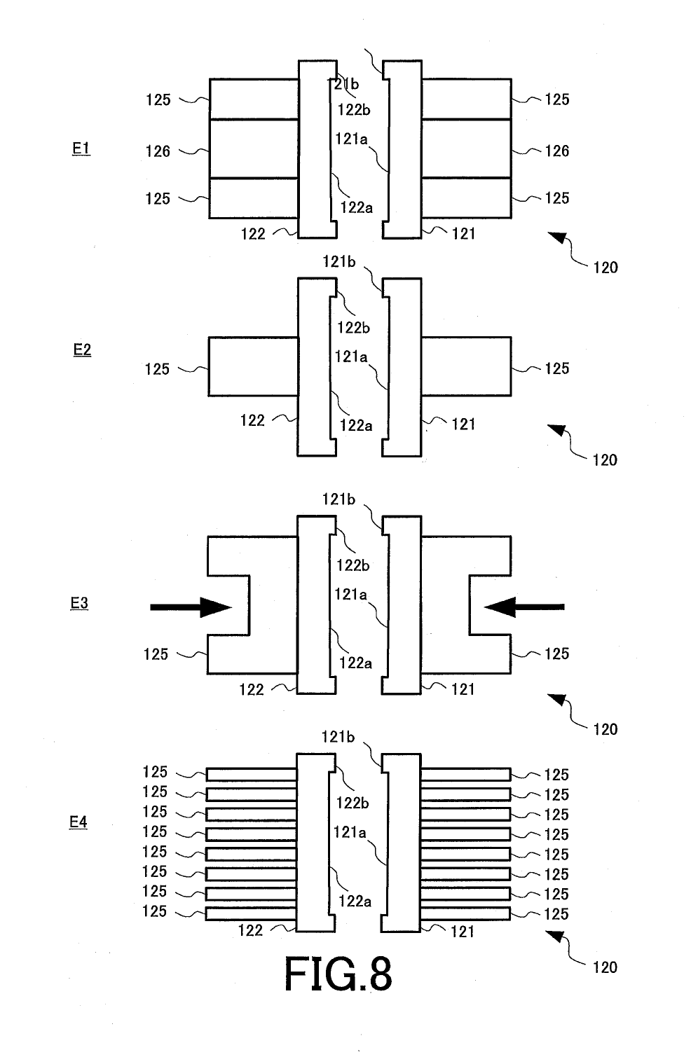

FIG. 8 (a) to FIG. 8 (d) are views illustrating a modification of the embodiment of FIG. 4. In this modification, various forms of cooling control units 125 are used. FIG. 8 (a) is a view illustrating a state in which a second cooling control unit 126 having a thermal expansion coefficient higher than that of the cooling control unit 125 is provided between cooling control units 125 provided at the circumferential edge portions of surfaces opposite to the inner circumferential surface 121a of the first die 121 and the inner circumferential surface 122a of the second die 122, respectively. FIG. 8 (b) is a view illustrating a state in which cooling control units 125 are provided only at the central portions of the surfaces opposite to the inner circumferential surface 121a of the first die 121 and the inner circumferential surface 122a of the second die 122. FIG. 8 (c) is a view illustrating a state in which recessed portions extending toward the central portions of the surfaces opposite to the inner circumferential surface 121a of the first die 121 and the inner circumferential surface 122a of the second die 122 are provided in cooling control units 125.

A case is illustrated in FIGS. 8 (a) to 8 (c) in which molten glass is generally pressed in the center of each inner circumferential surface 121a, 122a; however, when a location of the molten glass is shifted from the central portion of each inner circumferential surface, locations of the second cooling control unit 126 in FIG. 8 (a), the cooling control unit 125 in FIG. 8 (b), and the recessed portions in FIG. 8 (c) may be adjusted depending on the shift.

As illustrated in FIG. 8 (a), the second cooling control unit 126 is provided at the central portion of each of the surfaces opposite to the circumferential surface 121a of the first die 121 and the inner circumferential surface 122a of the second die 122. Here, for example, when the cooling control unit 125 is made of aluminum or an aluminum alloy, copper, a copper alloy or the like is used as a material of the second cooling control unit 126. By using the second cooling control unit 126, heat confined in the central portions of inner circumferential surfaces 121a and 122a during press forming is discharged to outside through the second cooling control unit 126 having heat conduction efficiency higher than that of the cooling control unit 125. Heat transferred to the circumferential edge portions of inner circumferential surfaces 121a and 122a from the gob G_{G} is discharged to outside through the cooling control unit 125. In this way, a difference in temperature of the interior of each of inner circumferential surfaces 121a and 122a during press forming can be reduced.

When the cooling control units 125 are provided only at the central portions of the surfaces opposite to inner circumferential surfaces 121a and 122a as illustrated in FIG. 8 (b), heat confined in the central portions of inner circumferential surfaces 121a and 122a during press forming is discharged to outside through the cooling control unit 125. In this way, a difference in temperature of the interior of each of inner circumferential surfaces 121a and 122a during press forming can be reduced. The second cooling control unit 126 may be provided in place of the cooling control unit 125.

Further, when a recessed portion extending toward the central portion of the surface opposite to each of inner circumferential surfaces 121a and 122a is provided in the cooling control unit 125 as illustrated in FIG. 8 (c), the recessed portion may be cooled using, for example, a liquid, a gas or the like having a cooling effect. In this case, the central portions of inner circumferential surfaces 121a and 122a are rapidly cooled, whereby a difference in temperature of the interior of each of inner circumferential surfaces 121a and 122a during press forming can be reduced. The cooling control unit 125 may be formed so that the central portion of the surface opposite to each of inner circumferential surfaces 121a and 122a can be directly cooled using, for example, a liquid, a gas or the like having a cooling effect.

As illustrated in FIG. 8 (d), a plurality of cooling control units 125 may be provided on the rear surface of each of first and second dies 121 and 122. In this case, as compared to the case in which one cooling control unit 125 is provided, the contact area of the cooling control unit to outside can be increased, and therefore heat transferred to inner circumferential surfaces 121a and 122a from the gob G_{G} can be efficiently discharged to outside.

Next, control of the cooling rate of the gob G_{G} will be described. When the cooling rate of the gob G_{G} is controlled by the cooling control unit 125 and/or temperature control mechanism over a period of time until the temperature of the gob G_{G} during press forming falls to a glass transition point (Tg) from a temperature at the start of pressing, a difference in temperature is generated between the surface portion (both end portions in the thickness direction) and the central portion (central portion in the thickness direction) of the gob G_{G}. At this time, shrinkage of the gob G_{G} associated with cooling of the gob G_{G} precedes at the surface portion, and therefore first compressive stress layers having a predetermined thickness are formed with physically strengthening on both sides of a pair of principal faces (surfaces on the both end sides in the thickness direction) of the glass blank after the press forming process. Here, physically strengthening is a strengthening method, for example, with which glass is rapidly cooled such that glass temperature reduces from a temperature above the annealing point to a temperature near the strain point to form a difference in temperature between the surface and the inner portion of the glass, and accordingly, a compressive stress layer is formed in the surface of the glass, and a tensile stress layer is formed in the inner portion of the glass.

For example, when a glass blank having a diameter of 75 mm and a thickness of 0.9 mm is manufactured, the cooling rate of the gob G_{G} is controlled to about −266° C./second over a period of time until the temperature of the gob G_{G} falls to a glass transition point (Tg: for example 500° C.) from a temperature (=1300° C.) at the start of pressing. Here, for example, “−266° C./second” is denoted when a temperature reduction per second is 266° C. In this case, first compressive stress layers having a thickness of 100 μm to 300 μm are formed on both sides of a pair of principal faces of the glass blank after the press forming process. Here, the thickness of the first compressive stress layer formed varies depending on the thickness and thermal expansion coefficient of the glass substrate, and when a glass substrate having a high thermal expansion coefficient is formed, the thickness of the first compressive stress layer is increased. As described previously, in this embodiment, a glass substrate having a thermal expansion coefficient, which is as high as that of a metallic spindle having a high thermal expansion coefficient, is formed, so that the thickness of the first compressive stress layer can be increased.

The temperature of the gob G_{G} may be measured using a thermocouple at a point which is located 1 mm from each of the front faces of the inner circumferential surface 121a of the first die 121 and the inner circumferential surface 122a of the second die 122 to the inside of the die and at which the inner circumferential surface 121a and the inner circumferential surface 122a face each other (e.g. a point corresponding to the central position of the glass blank and central points of the inner circumferential surface 121a and the inner circumferential surface 122a).

The cooling rate of the gob G_{G} may be appropriately controlled according to the composition of the glass and the size of the glass blank that is formed.

(b) Process of Removing First Compressive Stress Layer (Step S20)

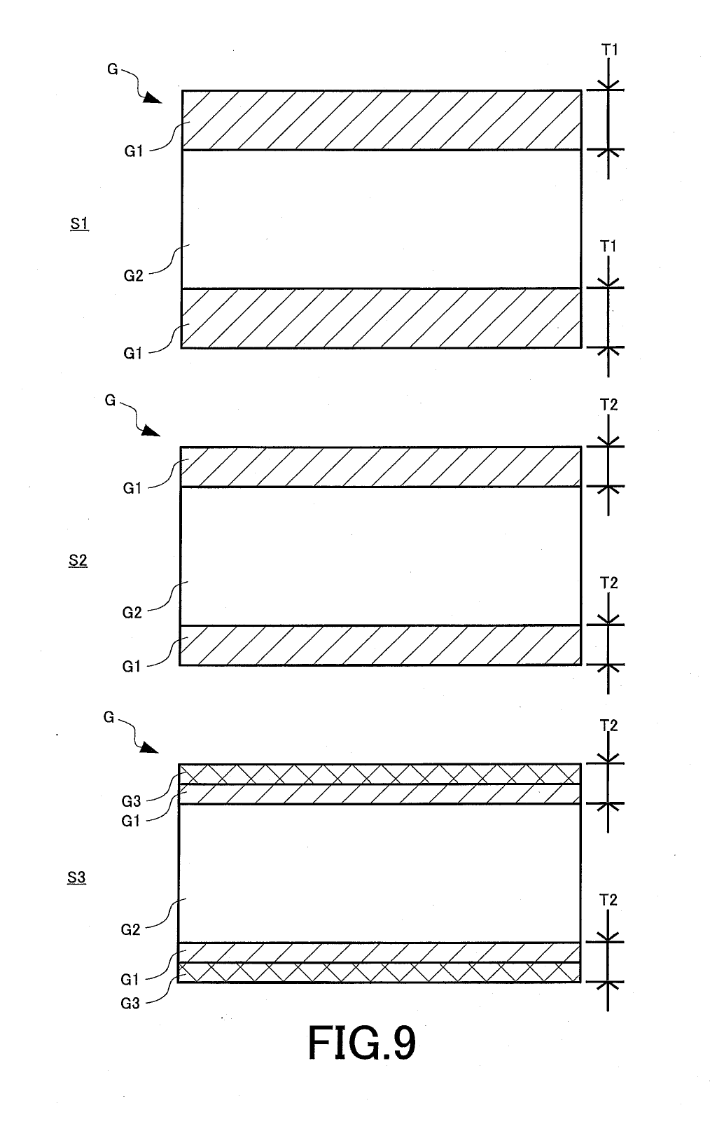

Next, a removing process may be performed for partially removing the first compressive stress layer formed on the glass blank after the press forming process. The process of removing the first compressive stress layer will be described with reference to FIG. 9. FIG. 9 (a) is a view illustrating a state of the compressive stress layer in the glass blank G before the removing process. FIG. 9 (b) is a view illustrating a state of the compressive stress layer in the glass blank G after the removing process. Regarding FIG. 9 (c), an explanation will be provided in the chemically strengthening process described later.

As illustrated in FIG. 9 (a), first compressive stress layers G1 having a thickness T1 are formed on both sides of a pair of principal faces of the glass blank G after the press forming process. On the other hand, in the glass blank G, shrinkage is suppressed by the first compressive stress layer G1 that has been previously formed. Consequently, a tensile stress layer G2 having a predetermined thickness is formed in the glass blank G. That is, in the glass blank G, a compressive stress in the first compressive stress layer G1 and a tensile stress in the tensile stress layer G2 are generated across the thickness direction of the glass blank G. The magnitude of the compressive stress generated in the first compressive stress layer G1 varies with the magnitude of the thickness of the first compressive stress layer G1. That is, the compressive stress increases as the thickness of the compressive stress layer G1 increases. The tensile stress generated in the tensile stress layer G2 increases as the compressive stress increases. In this case, the glass blank may be ruptured due to an internal strain by a stress when the glass blank is formed into a donut shape in the scribing process described later.

Accordingly, in the process of removing the first compressive stress layer G1, the principal face of the glass blank G after the press forming process is subjected to grinding processing (machining) using a grinding apparatus including a planet gear mechanism. Consequently, the first compressive stress layer G1 is removed in such a manner as to leave at least a part thereof, so that the thickness of the first compressive stress layer G1 decreases, and therefore the compressive stress generated in the first compressive stress layer G1 can be decreased. The tensile stress generated in the tensile stress layer G2 can also be decreased as the compressive stress decreases. Consequently, the internal strain by the stress generated in the glass blank G can be reduced without performing annealing treatment.

For example, the grinding has the machining allowance of several micrometers to about 100 micrometers. The grinding apparatus includes a pair of upper and lower surface plates (upper surface plate and lower surface plate), and a glass substrate is held between the upper surface plate and the lower surface plate. By moving one or both of the upper surface plate and the lower surface plate, the glass blank G and each surface plate are relatively moved, whereby both sides of a pair of principal faces of the glass blank can be ground.

When the first compressive stress layer G1 is removed until its thickness becomes T2 (T2<T1), as illustrated in FIG. 9 (b), in the removing process, the compressive stress and tensile stress generated in the glass blank G decrease.

Preferably the thickness of the first compressive stress layer G1 after the removing process is identical between a pair of principal faces.

(c) Scribing Process (Step S30)

Next, the scribing process will be described. In the scribing process, the glass blank G is subjected to scribing.

As used herein, the scribing means that two concentric (inside concentric and outside concentric) cutting lines (linear scratches, or cutting lines) are provided in the surface of the glass blank G with a scriber made of a super alloy or diamond particles in order to obtain the donut-shape (ring-shape) of the formed glass blank G having a predetermined size. It is preferred that two concentric cutting lines are provided at the same time. The glass blank G scribed into two-concentric-circle shape is partially heated, and a portion outside the outside concentric circle and a portion inside the inside concentric circle are removed by a difference in thermal expansion of the glass blank G. In this way, a donut-shaped glass substrate is obtained.

A donut-shaped glass substrate can also be obtained by forming a circular hole in the glass blank using a core drill or the like.

(d) Shape Processing Process (Step S40)

Next, the shape processing process will be described. The shape processing process includes chamfering processing of the end portion of the glass substrate (chamfering of outer circumferential end portion and inner circumferential end portion) after the scribing process. Chamfering processing is shape processing in which the outer circumferential end portion and inner circumferential end portion of the glass substrate after the scribing process is chamfered between a principal face and a side wall portion perpendicular to the principal face using a diamond abrasive grain. The chamfering angle is, for example, 40 to 50 degrees with respect to the principal face.

Here, the first compressive stress layer is formed on the principal face of the glass substrate in the press forming process of the step S10, while the compressive stress layer is not formed on the side wall portion. Therefore, since the strength of the side wall portion is lower than the strength of the principal face, the outer circumferential end portion and the inner circumferential end portion of the glass substrate can be easily chamfered by performing cutting from the side wall portion toward the principal face at the outer circumferential end portion and The inner circumferential end portion of the glass substrate.

(e) Grinding Process Using Fixed Abrasive Grain (Step S50)

Next, the glass substrate after the shape processing process may be subjected to a grinding process using a fixed abrasive grain. In the grinding process, the principal face of the glass substrate after the shape processing process is subjected to grinding processing (machining) using a grinding apparatus in the same manner as in the removing process of the step S20. Preferably the grinding has the machining allowance of, for example, several micrometers to about 100 micrometers so that the first compressive stress layer formed in the press forming process of the step S10 is left.

In the press forming process of this embodiment, a glass blank having extremely high flatness can be prepared, and therefore the grinding process may be omitted. Before the grinding process, a lapping process may be performed using a grinding apparatus similar to the apparatus used in the grinding process and an alumina loose abrasive grain.

(f) Edge Polishing Process (Step S60)

Next, edge polishing of the glass substrate after the grinding process is performed.

In edge polishing, the inner circumferential end face and outer circumferential end face of the glass substrate are subjected to mirror surface finishing by brush polishing. At this point, slurry that includes fine particles such as cerium oxide as the loose abrasive grain is used. By performing edge polishing, an impairment such as contamination by deposition of dust or the like, damage or a flaw is eliminated, whereby occurrence of a thermal asperity and deposition of ions of sodium, potassium and the like which may cause corrosion can be prevented.

(g) First Polishing Process (Step S70)

Next, the principal face of the glass substrate after the edge polishing process is subjected to first polishing. For example, first polishing has the machining allowance of about 1 μm to 50 μm. First polishing is intended to remove the flaw left on the principal face after the grinding using the fixed abrasive grain, the strain and the micro-surface irregularity (micro-waviness and roughness). In the first polishing process, polishing is performed while a polishing solution is fed using a double polishing apparatus having a structure similar to that of the apparatus used in the grinding process. A polishing agent contained in the polishing solution is, for example, a cerium oxide abrasive grain or a zirconia abrasive grain.

In the first polishing process, preferably polishing is performed so as to have a surface roughness (Ra) of 0.5 nm or less and a micro-waviness (MW-Rq) of 0.5 nm or less for the principal face of the glass substrate. When Ra and/or MW-Rq is 1.0 nm or less, the surface roughness and the micro-waviness can be sufficiently reduced by adjusting processing conditions in the second polishing process described later, and therefore the first polishing process can be omitted. The micro-waviness may be represented by a RMS (Rq) value calculated as a roughness at a wavelength bandwidth of 100 to 500 μm in a region of 14.0 to 31.5 mm radius in the whole of the principal face, and can be measured using, for example, Model-4224 manufactured by Polytec Inc.

The surface roughness is represented by an arithmetic mean roughness Ra defined in JIS B0601:2001 and, for example, can be measured with roughness measuring machine SV-3100 manufactured by Mitutoyo Corporation and calculated by a method defined in JIS B0633:2001 when the roughness is no less than 0.006 μm and no more than 200 μm. When as a result, the roughness is 0.03 μm or less, for example, the roughness can be measured with a scanning probe microscope (atomic force microscope) nanoscope manufactured by Veeco Instruments Inc. and can be calculated by a method defined in JIS R1683:2007. In the present application, an arithmetic mean roughness Ra as measured in a resolution of 512×512 pixels in a measurement area of 1 μm×1 μm square can be used.

(h) Chemically Strengthening Process (Step S80)

Next, the donut-shaped glass substrate after the first polishing process is chemically strengthened.

For example, a mixed solution of potassium nitrate (60% by weight) and sodium nitrate (40% by weight), or the like can be used as a chemically strengthening solution. In the chemically strengthening process, a chemically strengthening solution is heated to, for example, 300° C. to 400° C., a washed glass substrate is preheated to, for example, 200° C. to 300° C., and the glass substrate is then dipped in the chemically strengthening solution for, for example, 1 to 4 hours. That is, in this embodiment, the chemically strengthening process is performed using a low temperature-type ion exchange method.

When the glass substrate is dipped in the chemically strengthening solution, the lithium ion and the sodium ion in the surface layer of the glass substrate are replaced, respectively, by the sodium ion and the potassium ion which have relatively large ion radiuses in the chemically strengthening solution, so that a compressive stress layer (second compressive stress layer G3) is formed with chemically strengthening on the surface layer portion, thereby strengthening the glass substrate. The magnitude of a compressive stress generated in the second compressive stress layer G3 is, for example, 10 to 50 Kg/mm². The glass substrate subjected to the chemically strengthening treatment is washed. For example, the glass substrate is washed with sulfuric acid, and then washed with pure water or the like.

The second compressive stress layer G3 will be described with reference to FIG. 9 (c). FIG. 9 (c) is a view illustrating a state of a pressure stress layer of the glass substrate after the chemically strengthening process. As illustrated in FIG. 9 (c), on the glass substrate (illustrated by symbol G) after the chemically strengthening process, the second compressive stress layer G3 having a predetermined thickness (e.g. 10 to 100 μm) is formed on the principal face side of the first compressive stress layer G1 having a thickness T2. That is, the first compressive stress layer G1 formed with physically strengthening, and the second compressive stress layer G3 formed with chemically strengthening are laid to overlap each other in the glass substrate after the chemically strengthening process. The thickness of the second compressive stress layer G3 is smaller than that of the first compressive stress layer G1 formed in the press forming process of the step S10. The magnitude of a compressive stress generated in the second compressive stress layer G3 is almost equal to the magnitude of a compressive stress (10 to 50 Kg/mm²) generated in the first compressive stress layer G1. In this case, the thickness of the compressive stress layer including the first compressive stress layer G1 and the second compressive stress layer G3 is T2, and the magnitude of a compressive stress generated in the compressive stress layer is 10 to 100 Kg/mm². That is, a compressive stress layer having a large thickness and a high compressive stress can be formed on the glass substrate as compared to a case in which only one of the first compressive stress layer G1 and the second compressive stress layer G3 is formed.

In the chemically strengthening process, chemically strengthening may be performed using a high temperature-type ion exchange method, a dealkalization method, a surface crystallization method or the like in place of the low temperature-type ion exchange method.

(i) Second Polishing Process (Step S90)

Next, the glass substrate after chemically strengthening process is subjected to second polishing. Second polishing may preferably have the machining allowance of about 1 μm, more specifically in the range of 0.5 to 2 μn. When the machining allowance is smaller than that range, surface roughness may not be sufficiently reduced. When the machining allowance is greater than that range, edge shape may be degraded (roll-off, etc.). Second polishing is intended at the mirror surface polishing of the principal face. In second polishing, for example, the polishing apparatus used in first polishing is used. At this point, the second polishing differs from the first polishing in the following points: the kind and particle size of the loose abrasive grain, and hardness of the resin polisher.

For example, the slurry of the turbid fine particles such as colloidal silica (particle size: diameter of about 10 to 50 nm) is used as the loose abrasive grain used in the second polishing.

The polished glass substrate is washed with a neutral detergent, pure water, IPA or the like to obtain a glass substrate for magnetic disk.

In the second polishing process, compressive stress layers (first compressive stress layer G1 and second compressive stress layer G3) formed on a pair of principal faces of the glass substrate after the chemically strengthening process are partially removed. Consequently, the level of a surface irregularity of the principal face of the glass substrate can be further improved, and therefore it is preferred to perform the second polishing process. By performing the second polishing process, the principal face can be made to have roughness (Ra) of 0.15 nm or less, or more preferably 0.1 nm or less, and a micro-waviness (MW-Rq) of 0.3 nm or less, or more preferably 0.1 nm or less.

As described above, the method for manufacturing a glass blank for magnetic disk in this embodiment includes a press forming process of press-forming a lump of molten glass using a pair of dies. Therefore, when the surface roughness of the inner circumferential surfaces of a pair of dies is set at a good level (e.g. surface roughness required for the glass substrate for magnetic disk), the surface roughness of the glass blank can be kept at a good level because the surface roughness of the inner circumferential surface of the die is duplicated to form the surface roughness of the glass blank. In the press forming process, the cooling rate of the molten glass being pressed may be controlled so that the first compressive stress layer is formed on each of a pair of principal faces of a glass blank that is press formed. Further, the chemically strengthening process may be performed for forming the second compressive stress layer is formed on each of a pair of principal faces of a glass substrate formed using the glass blank after the press forming process. The glass substrate thus obtained includes a compressive stress layer formed with chemically strengthening, and a compressive stress layer formed with physically strengthening, and the compressive stress layers overlap each other. Then, the glass substrate has on the principal faces a compressive stress layer having a large thickness and a high compressive stress. Accordingly, in this embodiment, a glass substrate for magnetic disk having a principal face, the strength of which is further enhanced, is obtained as compared to a case in which only a chemically strengthening method is used.

It should be noted that an example of physically strengthening has been discussed in the present embodiment in which a cooling rate of the gob is controlled during press forming to form compressive stress layers in a pair of principal faces of a glass blank; however, physically strengthening is not limited to that method, and any other methods may be applied.

Here, a compressive stress value of the compressive stress layer formed in the press forming process may be equal to or less than a stress value that does not cause breaks in the scribing process. The stress value that does not cause breaks in the scribing process may be equal to or less than 0.4 kgf/mm² when measured with Babinet compensation method.

In this case, machining allowance for a single principal face with grinding in the process of removing first compressive stress layer may be preferably equal to or more than 3% of thickness of the glass blank G, since a portion of the maximum compressive stress value of the first compressive stress layer in a principal face needs to be removed. For example, machining allowance for a single principal face may be preferably equal to or more than 30 μm for 1 mm of thickness of a glass blank. Further, the maximum value of machining allowance with grinding for a single principal face is the same value as thickness of the stress layer (100 to 300 μm). From an aspect for enhancing machining efficiency, the maximum value of machining allowance with grinding for a single principal face may be preferably equal to or less than 10% of thickness of the glass blank G. For example, machining allowance for a single principal face may be preferably equal to or less than 100 μm for 1 mm of thickness of a glass blank.

Further, removal amount (machining allowance) per unit time with grinding for a single principal face may be preferably 3 to 8 μm/min. Preferably, removal amounts (and removal amounts per unit time) of both of a pair of principal faces of a glass blank are the same in order to suppress warp after the grinding.

As described above, when a compressive stress value of the compressive stress layer formed in the press forming process is equal to or less than a stress value that does not cause breaks in the scribing process, a glass substrate for magnetic disk having a principal face, the strength of which is further enhanced, can be obtained as compared to a case in which only a chemically strengthening method is used, while allowing to improve machinability.

[Magnetic Disk]

The glass substrate for magnetic disk is prepared through the processes described above. A magnetic disk is obtained in the following manner using the above-described glass substrate for magnetic disk.

The magnetic disk has, for example, a configuration in which on the principal face of the glass substrate, at least an adhesive layer, an underlying layer, a magnetic layer (magnetic recording layer), a protective layer and a lubricant layer are stacked in this order from the side closest to the principal face.

For example, the substrate is introduced into an evacuated deposition apparatus, and the adhesive layer, the underlying layer and the magnetic layer are sequentially deposited in an Ar atmosphere by a DC magnetron sputtering method. For example CrTi may be used as the adhesive layer, and for example CrRu may be used as the underlying layer. For example a CoPt-based alloy may be used as the magnetic layer. Also, a CoPt-based alloy or FePt-based alloy having a L₁₀ ordered structure may be deposited to form a magnetic layer for heat assisted magnetic recording. After the deposition described above, the protective layer is deposited using C₂H₄ by, for example, a CVD method, and subsequently nitriding treatment is performed to introduce nitrogen to the surface, whereby a magnetic recording medium can be formed. Thereafter, the lubricant layer can be formed by applying, for example, PFPE (perfluoropolyether) onto the protective layer by a dip coating method.

### EXAMPLES

The present invention will be further described below by way of Examples. However, the present invention is not limited to aspects described in Examples.

(1) Preparation of Molten Glass

Raw materials were weighed so as to obtain a glass having the following composition, and mixed to obtain a mixed raw material. This raw material was put in a melting vessel, heated, melted, clarified and stirred to prepare a homogeneous molten glass free from a foam and an unmelted substance. A foam and an unmelted substance, deposition of crystals, and contaminants such as a refractory material and platinum forming the melting vessel were not observed in the glass obtained.

### [Composition of Glass]

Amorphous aluminosilicate glass having a composition including 50 to 75% of SiO₂, 1 to 15% of Al₂O₃, 5 to 35% in total of at least one component selected from Li₂O, Na₂O and K₂O, 0 to 20% in total of at least one component selected from MgO, CaO, SrO, BaO and ZnO and 0 to 10% in total of at least one component selected from ZrO₂, TiO₂, La₂O₃, Y₂O₃, Ta₂O₅, Nb₂O₅ and HfO₂ in an oxide-based conversion indicated in mol %.

The above-described molten glass was provided, and a glass blank having a diameter of 75 mm and a thickness of 0.9 mm was prepared using a press forming method of the present invention (method using the apparatus in FIGS. 3 and 4). The temperature of a molten glass material L_{G} discharged from a molten glass outflow port 111 was 1300° C., and the viscosity of the molten glass material L_{G} at this time was 700 poise. The surface roughness (arithmetic mean roughness Ra) of the inner circumferential surfaces of a first die and a second die was 0.1 μm to 1 μm in the whole surface. Specifically, the surface roughness was adjusted to be 0.1 μm. Further, the first die and the second die were formed of an ultrahard alloy (e.g. VM40) in a thickness of 10 mm. Copper in a thickness of 20 mm was used as a cooling control unit.

The molten glass material L_{G} discharged from a molten glass outflow port 111 was cut by a cutting unit 160, so that a gob G_{G} having a thickness of about 20 mm is formed. The gob G_{G} was pressed under a load of 3000 kgf by a press unit until the gob G_{G} had a temperature equal to or lower than the strain point (=490° C.) of the molten glass material, so that a glass blank having a diameter of 75 mm and a thickness of 0.9 mm was formed.

In this Example, the temperature of the first die was set to the “strain point−20° C.”, and the temperature of the second die was set to the “temperature of the first die±10° C.” (“strain point−20° C.” to “strain point−30° C.”). The reason why the minimum temperature of the die was set to the strain point−30° C. is that when pressing was performed at a too low temperature, the glass may have been broken during pressing.

In this Example, the cooling rate of the molten glass material during press forming was controlled at −266° C./second over a period of time until the temperature of the molten glass material changed to a glass transition point (Tg: 500° C.) from a temperature (1300° C.) at the start of pressing. This cooling rate is determined by measuring a temperature for 60 seconds at a point which is located 1 mm from the front face of the inner circumferential surface of the die to the inside of the die, and calculating a ratio of a temperature change to the measurement time.

Next, glass substrates for magnetic disks were prepared by sequentially performing the processes of steps S30, S40 and S60 to S90 in FIG. 2 (i.e. processes except the process of removing a first compressive stress layer and the grinding process using a fixed abrasive grain) using the glass blanks after the press forming process.

In preparation of the glass substrate for magnetic disk, the processes of first polishing, chemically strengthening and second polishing were performed under the following conditions.
First polishing process: polishing was performed using cerium oxide (average particle size: 1 to 2 μm in diameter) and a hard urethane pad. The machining allowance was 10 μm.

Chemically strengthening process: a mixed solution of potassium nitrate (60% by weight) and sodium nitrate (40% by weight) was used as a chemically strengthening solution. The chemically strengthening solution was heated to about 380° C., a washed glass substrate was preheated to 200° C. to 300° C., and the glass substrate was then dipped in the chemically strengthening solution for 2 hours.
Second polishing process: polishing was performed using colloidal silica (average particle size: 0.1 μm in diameter) and a soft urethane pad. The machining allowance was 1 μm.

### Examples and Comparative Examples

### Comparative Example 1

In Comparative Example 1 illustrated in Table 1, a glass substrate was manufactured without controlling the cooling rate of a molten glass material during a press forming process. At this time, the cooling rate of the molten glass material was −30° C./second over a period of time until the temperature of the molten glass material changed to a glass transition point (Tg: 500° C.) from a temperature (1300° C.) at the start of pressing.

### Comparative Example 2

In Comparative Example 2 illustrated in Table 1, a glass blank was prepared while the cooling rate of a molten glass material was controlled to −266° C./second over a period of time until the temperature of the molten glass material changed to a glass transition point (Tg: 500° C.) from a temperature (1300° C.) at the start of pressing during the press forming process. A glass substrate was manufactured using the glass blank. The glass substrate was not subjected to a chemically strengthening process.

### Example 1

In Example 1 illustrated in Table 1, a glass blank was prepared while the cooling rate of a molten glass material was controlled to −266° C./second over a period of time until the temperature of the molten glass material changed to a glass transition point (Tg: 500° C.) from a temperature (1300° C.) at the start of pressing during the press forming process. A glass substrate was manufactured using the glass blank. The glass substrate was subjected to a chemically strengthening process.

### Evaluation of Examples and Comparative Examples

First, the cross section of the glass substrate for magnetic disk was polished, and a thickness of the compressive stress layer was measured with a polarization microscope.

Further, transverse rupture strength of the glass substrate for magnetic disk was measured. The transverse rupture strength was measured using transverse rupture strength tester (Shimadzu Autograph DDS-2000). Specifically, ten glass substrates were prepared for each of Comparative example 1, Comparative Example 2 and Example 1, and placed under a load, and an average of loads when the glass substrates were ruptured was determined as transverse rupture strength.

TABLE 1

| | | | Maximum | | |
|---|---|---|---|---|---|
| | | | of thickness | Compressive | |
| | | Chemically | of | stress value of | Transverse |
| | | strengthening | compressive | compressive | rupture |
| | Cooling rate | process | stress layer | stress layer | strength |
| Comparative | −30° C./second | Performed | 70 μm | 25 kg/mm² | 230 N |
| Example 1 | | | | | |
| Comparative | −266° C./second | Not | 150 μm | 20 kg/mm² | 120 N |
| Example 2 | | performed | | | |
| Example | −266° C./second | Performed | 150 μm | 45 kg/mm² | 400 N |

As apparent from Table 1, a glass substrate, which had a compressive stress layer having a large thickness, a high compressive stress value, and the enhanced transverse rupture strength of which, was obtained by controlling the cooling rate of a molten glass material during a press forming process and performing a chemically strengthening process. This indicates that the strength of the glass substrate was enhanced by controlling the cooling rate of the molten glass material to form a first compressive stress layer on the principal face of the glass blank, and further performing the chemically strengthening process to form a second compressive stress layer on the first compressive stress layer.

Using glass having the other components (Composition 2 and 3 of glass described below), the same experiments were conducted as those for the above-described Examples. Then, it was proved that the same level of results was obtained as described in Table 1 with regard to maximum of thickness of compressive stress layer, compressive stress value of compressive stress layer, and transverse rupture strength.

[Composition 2 of Glass]

Amorphous aluminosilicate glass (Tg: 630° C.; 80×10⁻⁷/° C. as average linear expansion coefficients of the glass at temperatures of 100° C. to 300° C.) having the following composition.

The glass substrate according to the present embodiment may be amorphous aluminosilicate glass having the following composition.

Glass material including, as a glass composition expressed in mol %,

56 to 75% of SiO₂,

1 to 11% of Al₂O₃,

more than 0% and 4% or less of Li₂O,

1% or more and less than 15% of Na₂O, and

0% or more and less than 3% of K₂O, and is substantially free of BaO;

a total content of alkali metal oxides selected from the group consisting of Li₂O, Na₂O, and K₂O is in a range of 6 to 15%;

a molar ratio of a content of Li₂O to a content of Na₂O(Li₂O/Na₂O) is less than 0.50;

a molar ratio of a content of K₂O to the total content of the alkali metal oxides {K₂O/(Li₂O+Na₂O+K₂O)} is 0.13 or less;

a total content of alkaline-earth metal oxides selected from the group consisting of MgO, CaO, and SrO is in a range of 10 to 30%;

a total content of MgO and CaO is in a range of 10 to 30%;

a molar ratio of the total content of MgO and CaO to the total content of the alkaline-earth metal oxides {(MgO+CaO)/(MgO+CaO+SrO)} is 0.86 or more;

a total content of the alkali metal oxides and the alkaline-earth metal oxides is in a range of 20 to 40%;

a molar ratio of a total content of MgO, CaO, and Li₂O to the total content of the alkali metal oxides and the alkaline-earth metal oxides {(MgO+CaO+Li₂O)/(Li₂O+Na₂O+K₂O+MgO+CaO+SrO)} is 0.50 or more;

a total content of oxides selected from the group consisting of ZrO₂, TiO₂, Y₂O₃, La₂O₃, Gd₂O₃, Nb₂O₅, and Ta₂O₅ is more than 0% and 10% or less; and

a molar ratio of the total content of the oxides to a content of Al₂O₃ {(ZrO₂+TiO₂+Y₂O₃+La₂O₃+Gd₂O₃+Nb₂O₅+Ta₂O₅)/Al₂O₃} is 0.40 or more.

[Composition 3 of Glass]

Amorphous aluminosilicate glass (Tg: 680° C.; 80×10⁻⁷/° C. as average linear expansion coefficients of the glass at temperatures of 100° C. to 300° C.) having the following composition.

Glass material including, as a glass composition expressed in mol %, 50 to 75% of SiO₂, 0 to 5% of Al₂O₃, 0 to 3% of Li₂O, 0 to 5% of ZnO, 3 to 15% in total of Na₂O and K₂O, 14 to 35% in total of MgO, CaO, SrO, and BaO and 2 to 9% in total of ZrO₂, TiO₂, La₂O₃, Y₂O₃, Yb₂O₃, Ta₂O₅, Nb₂O₅ and HfO₂,

a molar ratio [(MgO+CaO)/(MgO+CaO+SrO+BaO)] is in a range of 0.8 to 1, and

a molar ratio [Al₂O₃/(MgO+CaO)] is in a range of 0 to 0.30.

The embodiments of the present invention have been described in detail, but the method for manufacturing a glass substrate for magnetic disk according to the present invention is not limited to the aforementioned embodiments, and it is needless to say that various modifications and changes may be made without departing from the spirit of the present invention.

### DESCRIPTION OF REFERENCE SIGNS

1 . . . glass substrate for magnetic disk
125 . . . cooling control unit
126 . . . second cooling control unit
G . . . glass blank
G1 . . . first compressive stress layer
G3 . . . second compressive stress layer

1. A method for manufacturing a glass substrate for magnetic disk, the method comprising:
a forming process of press-forming a lump of molten glass using a pair of dies, during which the cooling rate of the molten glass during pressing is controlled so that a first compressive stress layer is formed on each of a pair of principal faces of a glass blank that is press formed; and
a chemically strengthening process for forming a second compressive stress layer on each of a pair of principal faces of a glass substrate formed using the glass blank after the forming process.

2. The method for manufacturing a glass substrate for magnetic disk according to claim 1, wherein in the forming process, the falling lump of molten glass is press-formed using the pair of dies from directions, each direction being orthogonal to the falling direction.

3. The method for manufacturing a glass substrate for magnetic disk according to claim 1, wherein in the forming process, press forming is performed so that the temperature of the press forming surface of the pair of dies is substantially identical.

4. The method for manufacturing a glass substrate for magnetic disk according to claim 1, wherein the temperature of the pair of dies is kept lower than the glass transition point (Tg) of the molten glass during a period of time from when the glass blank contacts the pair of dies to the time the glass blank separates from the pair of dies.

5. The method for manufacturing a glass substrate for magnetic disk according to claim 1, the method further comprising a polishing process for partially removing the first compressive stress layer and the second compressive stress layer formed on a pair of principal faces of the glass substrate after the chemically strengthening process.

6. A glass substrate for magnetic disk having a pair of principal faces, the glass substrate comprising a compressive stress layer formed with chemically strengthening, and a compressive stress layer formed with physically strengthening, the compressive stress layers being overlapping each other.

7. A glass substrate for magnetic disk according to claim 6, thickness of the glass substrate being 0.5 to 1.0 mm.
